(19) United States
(12) Patent Application Publication
(10) Pub. No.: US 2026/0312680 A1
(43) Pub. Date: Oct. 8, 2026

(54) Analysis of Multi-Lane Communication Links

(71) Applicant: Mellanox Technologies, Ltd., Yokneam (IL)

(72) Inventors: Hagai Abulyak, Migdal Haemek (IL); Maoz Nagler, Moshav Sde Yaakov (IL); Yaron Omer, Moshav Amirim (IL); Eitan Zahavi, Zichron Yaakov (IL); Anat Shrot, Nir Etsion (IL)

(21) Appl. No.: 19/430,403

(22) Filed: Dec. 23, 2025

Related U.S. Application Data
(60) Provisional application No. 63/782,609, filed on Apr. 3, 2025.

(51) Int. Cl. H04B 10/079

(52) U.S. Cl. CPC H04B 10/0791

(57) ABSTRACT

A system includes an interface and a processor. The interface is to receive performance measurements for a multi-lane communication link including transmission (TX) circuitry and reception (RX) circuitry that communicate with one another over a communication medium in multiple lanes. The processor is to calculate (i) a TX-side variation, between at least two of the lanes, in a TX-side performance measurement associated with the TX circuitry, and (ii) an RX-side variation, between the at least two of the lanes, in an RX-side performance measurement associated with the RX circuitry. The processor is to compare the TX-side variation with the RX-side variation, and to diagnose a health status of the link depending on comparison of the TX-side variation and the RX-side variation.

### CROSS-REFERENCE TO RELATED APPLICATIONS

This application claims the benefit of U.S. Provisional Patent Application 63/782,609, filed Apr. 3, 2025, whose disclosure is incorporated herein by reference.

### TECHNICAL FIELD

The present disclosure relates generally to communication systems, and particularly to methods and systems for analysis of multi-lane communication links.

### BACKGROUND

Modern data centers and other computing and communication systems typically comprise a large number of communication links that connect the various network elements to achieve increased bandwidth and improved reliability. Communication links may comprise optical and/or electrical cables. Some communication links transfer signals over multiple lanes in parallel to further increase bandwidth. Network management systems are typically required to track the status of the various communication links, and take appropriate actions in response to failures or other events.

### GENERAL DESCRIPTION

An embodiment that is described herein provides a system including an interface and a processor. The interface is to receive performance measurements for a multi-lane communication link including transmission (TX) circuitry and reception (RX) circuitry that communicate with one another over a communication medium in multiple lanes. The processor is to calculate (i) a TX-side variation, between at least two of the lanes, in a TX-side performance measurement associated with the TX circuitry, and (ii) an RX-side variation, between the at least two of the lanes, in an RX-side performance with the RX circuitry. The measurement associated processor is to compare the TX-side variation with the RX-side variation, and to diagnose a health status of the link depending on comparison of the TX-side variation and the RX-side variation.

In some embodiments, in diagnosing the health status, the processor is to detect a fault in the link depending on the comparison of the TX-side variation and the RX-side variation. In disclosed embodiments, based on the comparison, the processor is to identify one or both of: a type of the fault, and a location of the fault along the link. In an embodiment, in detecting the fault, the processor is to detect a condition indicative of potential future failure. In a disclosed embodiment, in detecting the fault, the processor is to verify that the fault is persistent and not transient. In an example embodiment, the processor is to select and output a recommended corrective action for correcting the fault.

In another embodiment, the processor is to perform an analysis of multiple different types of performance measurements associated with the TX circuitry and the RX circuitry, and, based on the analysis, to generate a prioritized list of recommended corrective actions.

In yet another embodiment, the processor is to correlate the health status with production-stage data of one or both of the TX circuitry and the RX circuitry of the link. The processor may correlate the health status with the production-stage data by applying a Machine Learning (ML) model.

In some embodiments, the processor is to issue an alert in response to the health status. In an embodiment, the RX-side variation includes a variation in an error metric between the at least two of the lanes, and the TX-side variation includes a variation in a signal quality metric between the at least two of the lanes. In another embodiment, the processor is to compare the TX-side variation with the RX-side variation upon finding that the RX-side variation exceeds a defined threshold. In some embodiments, the link is an electro-optical link, and the communication medium is an optical fiber.

In some embodiments, the link is part of a network comprising additional links, and the processor is to receive telemetry from the link and from one or more of the other links, and to reconstruct a topology of the network based on the telemetry. In an example embodiment, the processor is to identify a network misconfiguration based on the reconstructed topology of the network. In an embodiment, the processor is to further identify a type of the network misconfiguration, selected from a plurality of misconfiguration types.

In some embodiments, upon detecting that the link is down, the processor is to assess whether the link is down due to performance or due to intentional deactivation by a user. In an example embodiment, the processor is to assess whether the link is down due to performance or due to intentional deactivation, based on a comparison of event counts or timer values associated with the TX circuitry and the RX circuitry.

In a disclosed embodiment, in diagnosing the health status, the processor is to distinguish between a physical fault and an electrical fault in the link. In an embodiment, the processor is to evaluate a Bit Error Rate using a series of sliding-window calculations, (BER) wherein a given sliding-window calculation evaluates the BER over bits contained in a span of multiple defined window durations, the span being shifted relative to the span of a previous sliding-window calculation.

There is additionally provided, in accordance with an embodiment that is described herein, a system including an interface and a processor. The interface is to receive performance measurements for a communication link including transmission (TX) circuitry and reception (RX) circuitry that communicate with one another over a communication medium. The processor is to diagnose a health status of the link based on the performance measurements, and to correlate the health status with production-stage data of one or both of the TX circuitry and the RX circuitry of the link.

In an embodiment, the processor is to correlate the health status with the production-stage data by applying a decision-tree Machine Learning (ML) model. In some embodiments, the production-stage data includes one or more of: manufacturer details of the TX circuitry or RX circuitry, a test that the TX circuitry or RX circuitry passed, a component t used in the TX circuitry or RX circuitry, a batch identifier of a component used in the TX circuitry or RX circuitry, and a firmware version of the TX circuitry or RX circuitry.

There is also provided, in accordance with an embodiment that is described herein, a system including an interface and a processor. The interface is to receive telemetry indicative of performance of multiple communication links of a communication network. The processor is to reconstruct a topology of the communication network based on the telemetry, and to identify a network misconfiguration based on the reconstructed topology.

There is further provided, in accordance with an embodiment that is described herein, a system including an interface and a processor. The interface is to receive telemetry indicative of performance of multiple communication links of a communication network. The processor is to identify a fault in a communication link among the communication links, and to generate, based on the telemetry, a prioritized list of recommended corrective actions for correcting the fault.

There is further provided, in accordance with an embodiment that is described herein, a system including an interface and a processor. The interface is to receive telemetry indicative of performance of multiple communication links of a communication network. The processor is to identify that a communication link among the communication links is down, and to assess, based on the telemetry, whether the communication link is down due to performance or due to intentional deactivation by a user.

There is additionally provided, in accordance with an embodiment that is described herein, a method including receiving performance measurements for a multi-lane communication link including transmission (TX) circuitry and reception (RX) circuitry that communicate with one another over a communication medium in multiple lanes. A TX-side variation, between at least two of the lanes, in a TX-side performance measurement associated with the TX circuitry, is calculated. An RX-side variation, between the at least two of the lanes, in an RX-side performance measurement associated with the RX circuitry, is also calculated. The TX-side variation is compared with the RX-side variation. A health status of the link is diagnosed depending on comparison of the TX-side variation and the RX-side variation.

Another embodiment that is described herein provides a computer software product, the product including a tangible non-transitory computer-readable medium in which program instructions are stored. The instructions, when read by one or more processors, cause the one or more processors to receive performance measurements for a multi-lane communication link including transmission (TX) circuitry and reception (RX) circuitry that communicate with one another over a communication medium in multiple lanes, to calculate (i) a TX-side variation, between at least two of the lanes, in a TX-side performance measurement associated with the TX circuitry, and (ii) an RX-side variation, between the at least two of the lanes, in an RX-side performance measurement associated with the RX circuitry, to compare the TX-side variation with the RX-side variation, and to diagnose a health status of the link depending on comparison of the TX-side variation and the RX-side variation.

Yet another embodiment that is described herein provides a computer software product, the product including a tangible non-transitory computer-readable medium in which program instructions are stored. The instructions, when read by one or more processors, cause the one or more processors to receive performance measurements for a communication link including transmission (TX) circuitry and reception (RX) circuitry that communicate with one another over a communication medium, to diagnose a health status of the link based on the performance measurements, and to correlate the health status with production-stage data of one or both of the TX circuitry and the RX circuitry of the link.

Still another embodiment that is described herein provides a computer software product, the product including a tangible non-transitory computer-readable medium in which program instructions are stored. The instructions, when read by one or more processors, cause the one or more to processors receive telemetry indicative of performance of multiple communication links of a communication network, to reconstruct a topology of the communication network based on the telemetry, and to identify a network misconfiguration based on the reconstructed topology.

Another embodiment that is described herein provides a computer software product, the product including a tangible non-transitory computer-readable medium in which program instructions are stored. The instructions, when read by one or more processors, cause the one or more processors to receive telemetry indicative of performance of multiple communication links of a communication network, to identify a fault in a communication link among the communication links, and to generate, based on the telemetry, a prioritized list of recommended corrective actions for correcting the fault.

Yet another embodiment that is described herein provides a computer software product, the product including a tangible non-transitory computer-readable medium in which program instructions are stored. The instructions, when read by one or more processors, cause the one or more processors to receive telemetry indicative of performance of multiple communication links of a communication network, to identify that a communication link among the communication links is down, and to assess, based on the telemetry, whether the communication link is down due to performance or due to intentional deactivation by a user.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a system comprising plurality of multi-lane communication links of a data center, and a management system that diagnoses link health status, in accordance with an embodiment that is described herein;

FIGS. 2 and 3 are flow charts that schematically illustrate methods for diagnosing the health status of a multi-lane communication link, in accordance with embodiments that are described herein;

FIG. 4 is a flow chart that schematically illustrates a method for correlating the health status of a communication link with production data of link components, in accordance with an embodiment that is described herein;

FIG. 5 is a flow chart that schematically illustrates a method for reconstructing network topology from telemetry obtained from communication links, in accordance with an embodiment that is described herein;

FIG. 6 is a flow chart that schematically illustrates a method for filtering-out link-down events caused by intentional deactivation, in accordance with an embodiment that is described herein;

FIGS. 7A and 7B are illustrations showing a top view and a perspective view, respectively, of an optical transceiver module, in accordance with another embodiment that is described herein;

FIG. 8 depicts exemplary scenarios for use of an optical transceiver, in accordance with another embodiment that is described herein;

FIG. 9 is a block diagram that schematically illustrates an example of a network device, in accordance with another embodiment that is described herein;

FIG. 10 illustrates an example of a computing environment, in accordance with another embodiment that is described herein; and

FIG. 11 illustrates an example of a machine learning architecture, in accordance with yet another embodiment that is described herein.

### DETAILED DESCRIPTION OF EMBODIMENTS

### Overview

One of the major challenges in the management of data centers is fault detection in communication links. A large data center may comprise thousands of communication links. The tasks of diagnosing link health status, detecting actual or imminent faults, and prioritizing maintenance actions, are massive. This is true both during the initial bring-up phase when the data center is first established, and during ongoing operation.

Manual troubleshooting of individual links in such environments is time-consuming and inefficient, potentially leading to prolonged network downtime, reduced operational efficiency and high maintenance costs. Conventional automated monitoring solutions may detect problems but often lack the capability to distinguish between different types of faults or to pinpoint their locations within the communication path. Conventional solutions are also lacking in detecting performance degradation of a link before it develops into an actual failure.

Embodiments that are described herein provide improved methods and systems for diagnosing the health status of communication links. In the present context, the term “health status” refers to any information that is indicative of the present or predicted future performance or operational status of the communication link or components thereof. Health status may indicate, for example, whether or not the link is operating within its specified performance, or whether a certain fault exists or is predicted to occur. Health status may indicate such information with various levels of detail or quantitative measures. The term “fault” in this context refers to various failures, performance degradations and performance anomalies. As will be elaborated below, existing or predicted faults in a multi-lane link are often, although not necessarily, identified by excessive variation in performance metrics between lanes of the link, or by deviations from expected norms.

The disclosed techniques are described primarily in the context of a data center, purely by way of example. The disclosed techniques are generally applicable to any computing and communication system that comprises communication links.

In the disclosed embodiments, a given communication link comprises transmission (TX) circuitry and reception (RX) circuitry that communicate with one another over a communication medium. Transmission and reception are performed over multiple lanes in parallel. In most of the embodiments described below, the link is an optical link, the communication medium is an optical fiber, and the multiple lanes comprise multiple modulated optical carrier having different wavelengths. Alternatively, however, the link may comprise an electrical link, in which case the communication medium is an electrical cable and the lanes comprise, for example, multiple carriers having different carrier frequencies. More generally, the term “lanes” may refer to any physical or logical partitions of the resources of a communication link, over which data can be transferred in parallel.

In some embodiments, a data center management system comprises a processor that receives performance measurements (“telemetry”) from the TX circuitry and from various links. In the present the RX circuitry of context, the terms “performance measurements” and “telemetry” (which are used interchangeably herein) refer to any quantitative or qualitative data that is collected from various points along a link and are indicative of, for example, signal quality and health. Examples of performance metrics include, but are not limited to, various signal quality metrics such as Signal-to-Noise Ratio (SNR) and power level, various error metrics such as Bit Error Rate (BER), various operational status metrics such as data regarding module temperature, link down counters, time since last counter clear, and firmware status opcodes, and many others.

The processor diagnoses the health status of a given link by correlating the TX-side performance measurements and the RX-side performance measurements obtained for that link. The processor uses the fact that, in a healthy link, the performance is expected to be approximately uniform across the multiple lanes. Excessive variations in performance among the lanes may be indicative of a fault. Moreover, comparing the amount of variation (of the same performance measure or of different performance measures) between the TX side and the RX side of the link may provide valuable information as to the type of fault and the location of the fault along the link. Several demonstrative examples are given below.

Thus, in some embodiments, the processor calculates for a given link (i) a TX-side variation, between at least two of the lanes, in a TX-side performance measurement associated with the TX circuitry, and (ii) an RX-side variation, between the at least two of the lanes, in an RX-side performance measurement associated with the RX circuitry. The processor compares the TX-side variation with the RX-side variation, and diagnoses the health status of the link depending on comparison. The health status can be used for recommending a suitable corrective action for correcting the fault.

Additional embodiments described herein further enhance diagnostic capabilities by correlating link health status with production-stage data using machine learning models. In some embodiments the processor generates prioritized lists of recommended corrective actions based on analysis of multiple different performance measures.

Moreover, the disclosed techniques extend to network-level analysis, including topology reconstruction from telemetry data, identification of network misconfigurations, and assessment of whether link outages result from performance issues or intentional user actions. This multi-faceted approach provides data center administrators with actionable insights for maintaining optimal system performance across large-scale network infrastructures.

### System Description

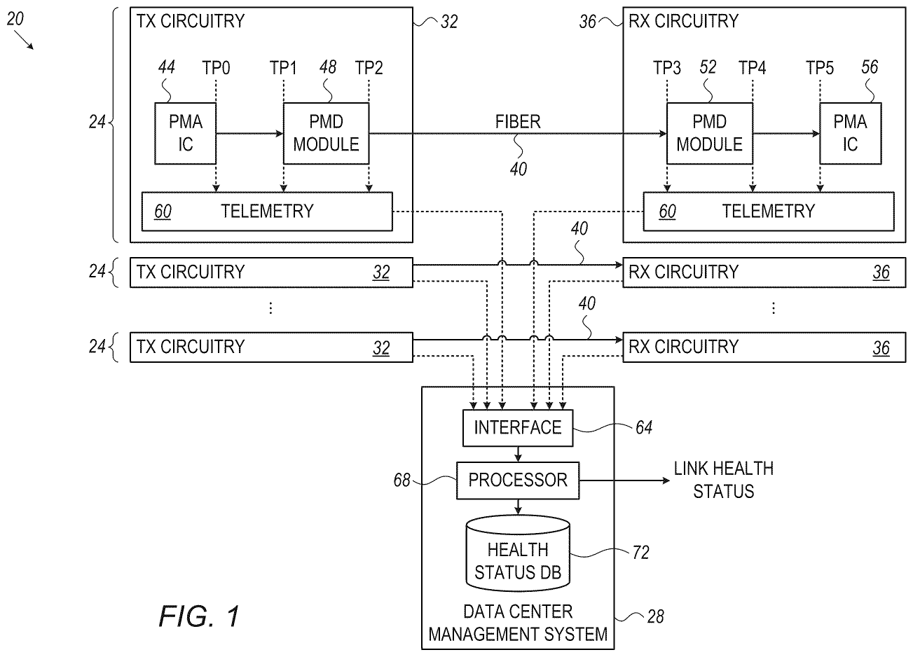

FIG. 1 is a block diagram that schematically illustrates a system 20 comprising multiple multi-lane communication links 24 of a data center, and a management system 28 that diagnoses link health status, in accordance with an embodiment that is described herein. Communication links 24 interconnect various network elements within the data center infrastructure, such as servers and switches. The network elements are not shown in the figure for the sake of clarity.

Each communication link 24 comprises TX circuitry 32 on the transmitting side and RX circuitry 36 on the receiving side, which communicate with one another over a communication medium using multiple lanes in parallel. In the present example, each link 24 is an optical link in which the communication medium is an optical fiber 40. Each lane comprises a modulated optical carrier transmitted by TX circuitry 32 on a respective wavelength, transferred over fiber 40, and received by RX circuitry 36.

TX circuitry 32 comprises, among other components, a Physical Medium Attachment (PMA) Integrated Circuit (IC) 44 and a Physical Medium Dependent (PMD) module 48. PMA IC 44 carries out transmit-side tasks specified in the PMA sub-layer of the applicable communication protocol. PMD module 48 comprises an electro-optical transceiver that carries out transmit-side tasks specified in the PMD sub-layer of the communication protocol. Typically, PMA IC 44 generates an analog multi-lane electrical signal. PMD module 48 converts this electrical signal into a multi-lane optical signal for transmission over fiber 40.

Test points denoted TP0, TP1, and TP2 are positioned along the transmission path of TX circuitry 32, to enable monitoring of the multi-lane signal characteristics at various stages. TP0 monitors the electrical signal at the output of PMA IC 44. TP1 monitors the electrical signal at the input of PMD module 48. Typically, TP0 is located on the circuit board of TX circuitry 32, immediately adjacent to the output of IC 44, whereas TP1 is located at the input to module 48. The signals at TP0 and TP1 can be used, for example, for monitoring electrical Signal-to-Noise Ratio (SNR) and/or pre-error-correction Bit Error Rate (BER).

TP2 monitors the optical signal generated by module 48. TP2 may be located, for example, adjacent to a Media-Dependent Interface (MDI—not seen in the figure) that couples TX circuitry 32 to fiber 40. The signal at TP2 can be used, for example, for monitoring transmission power level, optical SNR and/or TX bias (the DC current consumed by the optical signal source, e.g., laser, in order to maintain the appropriate operating point).

TX circuitry 32 further comprises a telemetry module 60 that collects performance measurements from TP0, TP1 and TP2. These performance measurements may include, for example, signal quality metrics such as SNR and power levels for each of the multiple lanes. The performance measurements are also referred to herein as “telemetry”. The telemetry collected from TP0 and TP1 pertains to electrical signals, and the telemetry collected from TP2 pertains to the optical signal at this test point.

Similarly, RX circuitry 36 comprises, among other components, a PMD module 52 and a PMA IC 56. PMD module 52 comprises an electro-optical transceiver that carries out receive-side tasks specified in the PMD sub-layer of the communication protocol. PMA IC 56 carries out receive-side tasks specified in the PMA sub-layer of the communication protocol. Typically, PMD module 52 receives the multi-lane optical signal from fiber 40 and converts it into an analog multi-lane electrical signal. PMA IC 56 receives and decodes the analog signal.

Test points denoted TP3, TP4, and TP5 are positioned along the reception path of RX circuitry 36, to enable monitoring of the multi-lane signal characteristics at various stages. TP3 monitors the optical signal received from fiber 40, at the input of PMD module 52, e.g., adjacent to the MDI that couples fiber 40 to module 52. TP4 monitors the electrical signal produced by PMD module 52, e.g., immediately adjacent to the PMD module. TP5 monitors the electrical signal at the input of PMA IC 56, e.g., on the circuit board of RX circuitry 36.

The signal at TP3 can be used, for example, for monitoring received power level, optical SNR and/or pre-error-correction BER. The signals at TP4 and TP5 can be used, for example, for monitoring pre-error-correction BER and/or physical-layer electrical SNR.

RX circuitry 36 further comprises a telemetry module 60 that collects performance measurements from TP3, TP4 and TP5. These performance measurements may comprise, for example, error metrics such as bit error rates for each of the multiple lanes. The telemetry collected from TP3 pertains to an optical signal, while telemetry collected at TP4 and TP5 pertains to electrical signals.

System 20 further comprises a data center management system 28 that analyzes the health status of the various communication links 24. Management system 28 comprises an interface 64, a processor 68, and a health status database 72. Interface 64 receives telemetry data from telemetry modules 60 of TX circuitry 32 and RX circuitry 36 of the various communication links 24. In this manner, interface 64 acts as a bridge that connects processor 68 of management system 28 to the various test points (TP0-TP5) along the physical communication links 24. The telemetry obtained from TX circuitry 32 is referred to herein as “TX-side telemetry” or “TX-side performance measurements”. The telemetry obtained from RX circuitry 36 is referred to herein as “RX-side telemetry” or “RX-side performance measurements”.

Processor 68 analyzes the received telemetry to diagnose the health status of each communication link 24 by calculating variations in performance measurements between lanes on both the TX side and RX side, comparing these variations, and determining the health status based on the comparison results. These techniques are described in greater detail below. Health status database 72 stores the diagnosed health status information and may maintain historical performance data for trend analysis and predictive maintenance purposes. Processor 68 may output some of all of the health status information, e.g., by issuing an alert to a user or to another computerized system.

In various embodiments, telemetry modules 60 in TX circuitry 32 and RX circuitry 36 may evaluate the various performance metrics in various ways. For example, in some embodiments BER is evaluated using a “sliding window” calculation. In this implementation, a window duration is defined over the signal timeline. Module 60 or processor 68 performs each BER calculation over the bits contained in a span of N window durations (e.g., N=3). The next BER calculation is performed over N window durations shifted by one window duration.

In some embodiments, at least some of the telemetry information is sent from modules 60 to processor 68 as opcodes. The following table lists a number of non-limiting example opcodes:

| Opcode | Description |
|---|---|
| 1-Port is close by command | Port is administratively |
| | disabled. |
| 2-AN failure | Both sides did not agree on |
| | speed/FEC or DME is missing. |
| 3-AN failure | Ack not received. |
| 4-AN failure | Next-page exchange failed. |
| 5-Link training failure. | Frame lock not acquired. |
| 6-Link training failure. | Link inhibit timeout. |
| 7-Link training failure. | Link partner did not set |
| | receiver ready. |
| 8-Link training failure. | Tuning didn't complete. |
| 9-Logical mismatch between | Did not acquire block lock. |
| link partners | |
| 10-Logical mismatch between | Did not acquire AM lock (NO |
| link partners | FEC). |
| 11-Logical mismatch between | Did not get align_status. AN |
| link partners | is done but the signal is |
| | not locked. Very rare. |
| 12-Logical mismatch between | FC FEC is not locked. |
| link partners | |
| 13-Logical mismatch between | RS FEC is not locked. |
| link partners | |
| 14-Remote fault received | Partner is not moving to |
| | sending Idles, check peer |
| | side Rx. |
| 15-Bad signal integrity | Post-Fec BER is beyond the |
| | threshold. |
| 16-Cable compliance code | Cable declared supported |
| mismatch (protocol mismatch | rates do not match port |
| between cable and port) | configuration. |
| 36-No Partner detected | Peer side is not sending |
| during force mode. | expected signals |
| 38-AN failure | FEC mismatch during |
| | override. |
| 39-AN failure | No HCD. |
| 57-signal not detected | Unable to detect incoming |
| | signal. |
| 59-Did not get module conf | Module configuration did not |
| done | finish, or a module error |
| | occurred |
| 128-Troubleshooting in | FW is currently attempting |
| process | to identify the issue |
| 1024-Cable is unplugged | No physical transceiver |
| | detected in cage. |
| 1026-Bus stuck (I2C Data or | Received failure on the I2C |
| clock shorted) | EEPROM communication line. |
| 1027-Bad/unsupported EEPROM | Failed to read EEPROM from |
| | transceiver or transceiver |
| | id is not recognized. |
| 1028-Part number list | Transceiver is not permitted |
| | by vendor list. |
| 1029-Unsupported cable. | Module is not supported. |
| 1030-Module temperature | Module temperature exceeded |
| shutdown | allowed threshold. |
| 1031-Shorted cable | Receive over current alert |
| | on the transceiver. |
| 1032-Power budget exceeded | Board power budget have |
| | exceeded. |
| 1033-Management forced down | Module shutdown by server |
| the port | command. |
| 1034-Module is disabled by | Module admin status is |
| command | disabled. |
| 1047, 1048-Modules DataPath | Failed to configure speed |
| FSM fault | (application) by |
| | transceiver. |

The configuration of system 20, including links 24 and the internal configurations of RX circuitry 32, TX circuitry 36 and management system 28, as illustrated in FIG. 1, are example configurations that are chosen purely for the sake of conceptual clarity. In alternative embodiments, any other suitable configurations can be used.

In various embodiments, RX circuitry 32, TX circuitry 36 and management system 28 may be implemented using suitable hardware, such as in one or more Application-Specific Integrated Circuits (ASICs) or Field-Programmable Gate Arrays (FPGAs), using software, or using a combination of hardware and software elements. Elements that are not mandatory for understanding of the disclosed techniques have been omitted from the figure for the sake of clarity.

In some embodiments, some functions of system 20, e.g., some or all of the functions of telemetry modules 60 and processor 68, may be implemented using one or more general-purpose processors, which are programmed in software to carry out the functions described herein. Software may be downloaded to any of such processors in electronic form, over a network, for example, or it may, alternatively or additionally, be provided and/or stored on non-transitory tangible media, such as magnetic, optical, or electronic memory.

### Link Health Diagnosis Using TX-Side and RX-Side Performance Variations Across Lanes

In some embodiments, processor 68 receives TX-side performance measurements from TX circuitry 32 of the various links 24, and RX-side performance measurements from RX circuitry 36 of the various links 24. For a given link 24, processor 68 diagnoses the health status of the link by correlating the TX-side performance measurements and the RX-side performance measurements.

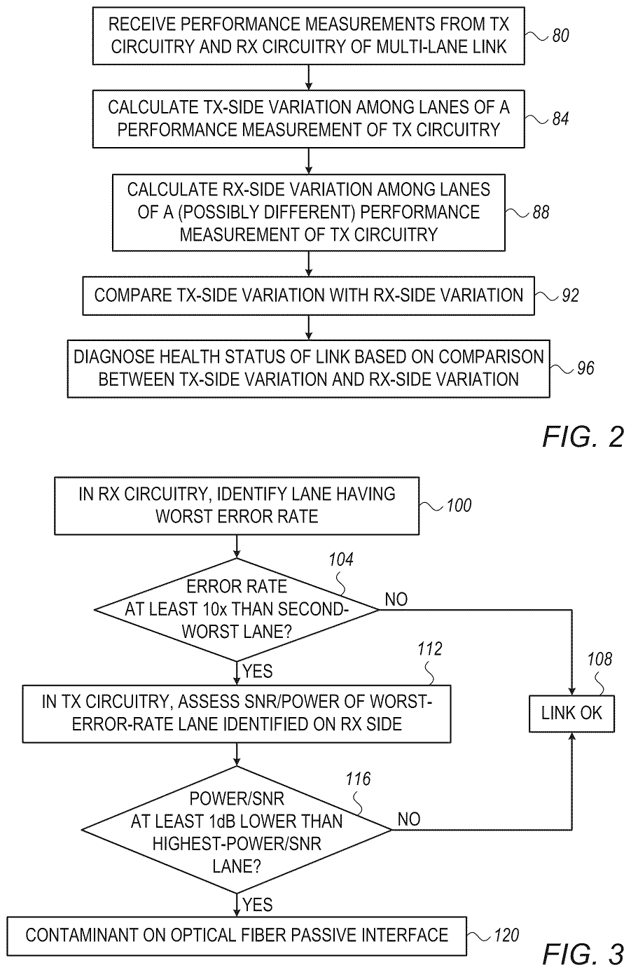

FIG. 2 is a flow chart that schematically illustrates a method for diagnosing the health status of a multi-lane communication link, in accordance with an embodiment that is described herein.

The method begins at a telemetry input stage 80, in which interface 64 of data center management system 28 receives performance measurements from TX circuitry 32 and RX circuitry 36 of a certain multi-lane communication link 24. Interface 64 receives this telemetry data from telemetry modules 60 of TX circuitry 32 and RX circuitry 36.

At a TX-side variation calculation stage 84, in which processor 68 calculates a TX-side variation between at least two of the lanes in a TX-side performance measurement associated with the TX circuitry. In parallel or subsequently, at an RX-side variation calculation stage 88, processor 68 calculates an RX-side variation between the corresponding lanes in an RX-side performance measurement associated with the RX circuitry.

The TX-side performance measurement being evaluated may be the same type of performance measurement as the RX-side performance measurement, or a different type. See a specific example in FIG. 3 below.

Following the calculation of both variations, at a comparison stage 92, processor 68 compares the TX-side variation with the RX-side variation. Finally, at a diagnosis stage 96, processor 68 diagnoses the health status of link 24 depending on the comparison between the TX-side variation and the RX-side variation. Processor 68 may store the resulting health status information in health status database 72, and/or provide the health status information as output, e.g., as an alert.

FIG. 3 is a flow chart that schematically illustrates a method for diagnosing the health status of a multi-lane communication link, in accordance with another embodiment that is described herein. The underlying principle of this method is the following:
On the RX side, evaluate the difference in a certain performance metric between the worst-performing lane and the next-worst-performing lane.
If the difference exceeds a defined threshold, evaluate the difference on the TX side in a certain performance metric (not necessarily the same performance metric evaluated on the RX side) between the same two lanes.
If the difference on the TX side exceeds a defined threshold, declare a fault.

The method of FIG. 3 provides a concrete example of identifying a specific type of fault at a specific location in link 24, namely the presence of a contaminant on the passive interface of optical fiber 40. This non-limiting example demonstrates the joint analysis of TX-side variations and RX-side variations in performance across lanes.

The method begins at an RX-side worst lane selection stage 100, in which processor 68 identifies the lane having the worst error rate (typically Bit Error Rate-BER) among the multiple lanes of link 24 on the RX side. To identify the worst error rate lane, processor 68 typically examines the RX-side telemetry obtained from test point TP5 in RX circuitry 36.

At an RX-side variation checking stage 104, processor 68 checks whether the error rate of the worst lane is at least 10× (an order of magnitude) higher than the error rate of the second-worst lane. If the error rate variation does not meet this condition, the method moves to a termination stage 108, in which processor 68 determines that the link performance is acceptable.

If the error rate variation meets the condition of stage 104, the method continues to a TX-side lane selection stage 112, in which processor 68 assesses the SNR or power level of the same lane that was identified as having the worst error rate on the RX side, but now examining this lane in the telemetry obtained from TX circuitry 32. In this example, the power and/or SNR being assessed is the optical power/SNR, in the signal obtained from test point TP1 or TP3.

Then, at an RX-side variation checking stage 116, processor 68 checks whether the power or SNR of the selected lane is at least 1 dB lower than the highest-power or highest-SNR lane among all lanes. If the power or SNR does not meet this criterion, the method returns to termination 108, stage in which processor 68 determines that the link performance is acceptable.

If the power or SNR meets the criterion of stage 116, at a diagnosis stage 120, processor 68 decides on a diagnosis—Presence of a contaminant on the optical fiber passive interface. Processor 68 may store this diagnostic information in health status database 72 and/or provide the information as output.

The method flows of FIGS. 2 and 3 are non-limiting example flows that are chosen purely for the sake of conceptual clarity. Any other suitable flow can be used in alternative embodiments. For example, in a slight variation of the method of FIG. 3, at stage 112, processor 68 may examine the TX-side electrical power/SNR (at test point TP0 or TP1) instead of the optical power/SNR (at test point TP2). In this variation, if (i) the RX-side BER varies by more than 10× between the worst and second worst lane, and (ii) the TX-side electrical power/SNR varies by less than 1 dB over the same lanes, processor 68 may diagnose a different fault-Signal lock degradation between RX circuitry 36 and its host system.

One of the benefits of the disclosed technique is the ability to distinguish between physical faults (e.g., contaminants on a fiber interface) and electrical faults (e.g., performance degradation or failure in TX or RX circuitry) in a link.

### Additional Embodiments

In some embodiments, processor 68 may enhance fault detection capabilities by implementing persistence verification mechanisms. When a fault is initially detected, e.g., through the comparison of TX-side and RX-side variations, processor 68 may continue monitoring the link over a defined time period to verify that the fault condition is persistent rather than transient. This approach may help distinguish between temporary performance fluctuations and genuine hardware or configuration issues that require corrective action.

In some embodiments, processor 68 may correlate the diagnosed health status with production-stage data obtained during the manufacturing or initial testing phases of the TX circuitry 32 and/or RX circuitry 36. Production data may comprise, for example, manufacturer details, tests the circuitry has passed, components used, component batch identifiers, firmware version, and others. This correlation may be performed using machine learning models that analyze patterns between current operational telemetry and historical production data. In an example implementation, processor 68 applies a decision-tree Machine Learning (ML) model to identify the most indicative production data features and their combinations, highlighting the top correlating factors related to a fault indicated by the health status.

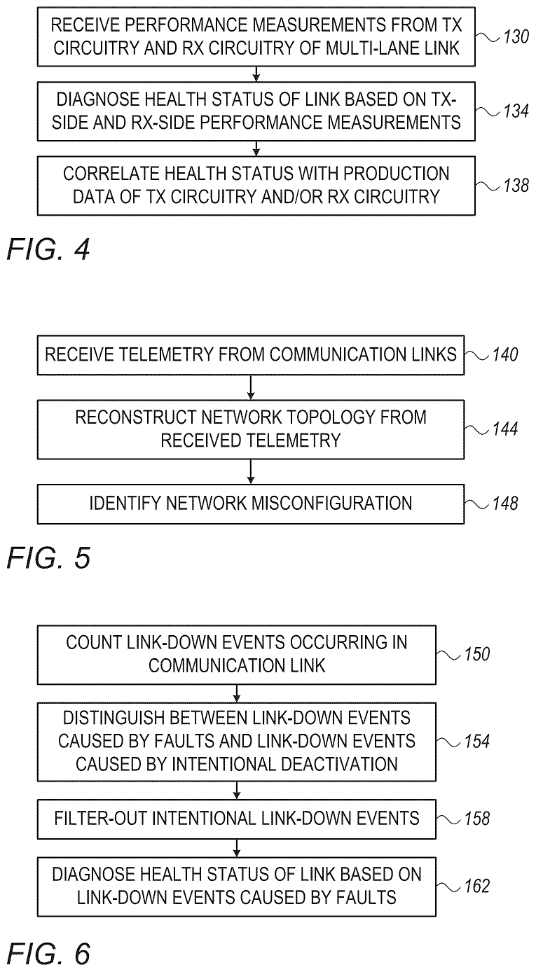

FIG. 4 is a flow chart that schematically illustrates a method for correlating the health status of a communication link with production data of link components, in accordance with an embodiment that is described herein. The method begins with processor 68 receiving performance measurements from TX circuitry 32 and RX circuitry 36 of a certain link 24, at a telemetry input stage 130. At a health diagnosis stage 134, processor 68 diagnoses the health status of link 24 based on the received performance measurements. Processor 68 may use any of the performance measurements, health status information and diagnosis techniques described herein. At a correlation stage 138, processor 68 correlates the health status with production data of TX circuitry 32 and/or RX circuitry 36.

Correlation of health status with production-stage data is a powerful tool that can improve both network management and maintenance. As just one example, faults in a live system can be correlated with specific component batches, to identify problematic batches and enable preventive maintenance before additional faults occur.

In some embodiments, processor 68 may perform comprehensive analysis of multiple different performance measures associated with both the TX circuitry 32 and RX circuitry 36. Based on this multi-dimensional analysis, the processor 68 may generate prioritized lists of recommended corrective actions for addressing detected faults. The prioritization may consider factors such as fault severity, potential impact on network performance, and resource requirements for implementing the corrective measures. The prioritization may comprise (i) prioritization among two or more links 24 of system 20 in which faults were detected, and/or (ii) prioritization among two or possible more corrective measures recommended for a specific link 24 in which a fault was detected.

In an embodiment, when faults are detected in multiple links 24, processor 68 may prioritize the corrective actions in the following order (in descending order of priority):
Links showing an increase in repetitive link up/down events (typically excluding link-down events caused by intentional user deactivation).
Links having post-FEC error rates exceeding the specified limit. In some embodiments, links connected directly to end systems (e.g., network adapters of servers) are given higher priority than switch-to-switch links.
Links whose post-FEC error rates exhibit a large difference between the TX-side variation across lanes and the RX-side variation across lanes.
Links that are not in active state, but are listed in the topology file.

In an embodiment, for a specific link 24 in which a fault was detected, processor 68 may use the following prioritization:
If RX circuitry 36 of the link exhibits both a pre-FEC BER issue and a post-FEC BER issue, the link is given high priority since this indicates actual errors in the link.
If a fault is identified in TP5 and also in TP1 or TP2, the fault is most likely in PMA IC 44 or PMD module 48.
If a fault is identified in TP5 and also in TP3, the fault is most likely in the passive optical medium (fiber 40 or its physical interfaces to PMD module 48 or 52).
If a fault is identified in TP5 and also in TP4, the fault is most likely in the electrical connection between PMD module 52 and PMA IC 56 in RX circuitry 36.

The disclosed techniques may extend beyond analysis of individual links 24, to encompass network-level monitoring and management capabilities. For example, processor 68 may receive telemetry data from multiple communication links 24 throughout the data center, and use this information to reconstruct the topology of the communication network. By analyzing connectivity patterns, signal propagation characteristics, and performance correlations between different links, processor 68 may build a comprehensive map of the network infrastructure.

Based on the reconstructed network topology, processor 68 may identify various types of network misconfigurations. In the present context, the term “misconfiguration” refers both to wrong connectivity (e.g., a cable connecting an incorrect pair of ports) and to wrong setting of link parameters on the TX and/or RX side. Another type of misconfiguration is a suboptimal routing configuration. Any such misconfiguration could impact overall network performance. Processor 68 may categorize identified misconfigurations into different types, such as physical layer misconfigurations, protocol mismatches, or bandwidth allocation issues. In an example embodiment, processor 68 may carry out the following process:
Receive a topology file specifying the expected network topology.
Based on telemetry from telemetry modules 60 (e.g., using link layer discovery protocol-LLDP), verify whether all links 24 are connected as expected. Detect which TX circuitry 32 is connected to which RX circuitry 36, thereby producing the actual network topology.
Find any discrepancy between the expected network topology and the actual network topology.
Additionally, find any discrepancy between the expected network configuration (planned link parameters) and the actual network configuration (derived from telemetry).

FIG. 5 is a flow chart schematically that illustrates a method for reconstructing network topology from telemetry obtained from communication links, in accordance with an embodiment that is described herein. The method begins with processor 68 receiving telemetry information from TX circuitry 32 and/or RX circuitry of various communication links 24, at a telemetry reception stage 140. At a topology reconstruction stage 144, processor 68 reconstructs the network topology based on the received telemetry. At a misconfiguration detection stage 148, processor 68 identifies a misconfiguration in the reconstructed topology.

In some embodiments, processor 68 may implement sophisticated analysis techniques to distinguish between different causes of link outages. For example, when a 24 is detected as being down, communication link processor 68 may assess whether the outage results from performance degradation or from intentional deactivation by a user or automated system. This assessment may be performed by comparing counts of TX-side events associated with TX circuitry 32 and RX-side events associated with RX circuitry 36. Patterns in these event counts may indicate whether the link failure originated from hardware issues, configuration changes, or deliberate shutdown procedures. Any suitable type of events, e.g., faults or noticeable performance degradations, can be used for this purpose.

One example of an intentional deactivation is a reboot of a device (e.g., switch, network adapter or server) that hosts the TX or RX side of a link. Consider a scenario in which multiple links 24 are connected to respective ports of a switch, network adapter, server, or other device. In an embodiment, processor 68 holds a counter that counts the total number of link-down events of a certain link 24 (possibly a respective counter for h 1 each link 24). Unless accounted for, the counter will typically count both link-down events caused by faults, and link-down events caused by rebooting of the entire device (e.g., entire switch, network adapter or server). To filter-out link-down events caused by rebooting of the device, processor 68 may examine the ‘time_since_last_clear’ counters for the various ports of the network device. Each ‘time_since_last_clear’ counter is reset on link-up and starts counting, and is therefore indicative of the up-time of the respective link (the time duration for which the link has been up, or the time that elapsed since the most recent link-down event). If the maximum ‘time_since_last_clear’ counter value for the device is greater than the ‘time_since_last_clear’ counter value for the link being evaluated, processor 68 may conclude that the count of link-down events of the link does not include link-down events caused by rebooting.

FIG. 6 is a flow chart that schematically illustrates a method for filtering-out link-down events caused by intentional deactivation, in accordance with an embodiment that is described herein. The method begins with processor 68 counting link-down events that occur in a certain link 24 over a certain time period, at a link-down counting stage 150. At an event classification stage 154, processor 68 distinguishes between link-down events that are caused by genuine faults, and link-down events that are caused by intentional deactivation of the link of parts thereof. At a filtering stage 158, processor 68 filters-out the link-down events that are caused by intentional deactivation. After this stage, the count of link-down evets is indicative of the number of actual faults that occurred during the defined time period. At a health diagnosis stage 162, processor 68 diagnoses the health status of link 24 based on the filtered count of link-down events.

Processor 68 may also implement predictive analysis capabilities that identify conditions indicative of potential future failures. By analyzing trends in performance measurements over time and correlating them with historical failure patterns, processor 68 may detect early warning signs of imminent link degradation. This proactive approach may enable preventive maintenance actions to be taken before actual failures occur, thereby reducing network downtime and improving overall system reliability.

### APPENDIX

The Appendix below provides examples of embodiments that may be used in a data center that employs the disclosed techniques, e.g., in system 20 of FIG. 1 above.

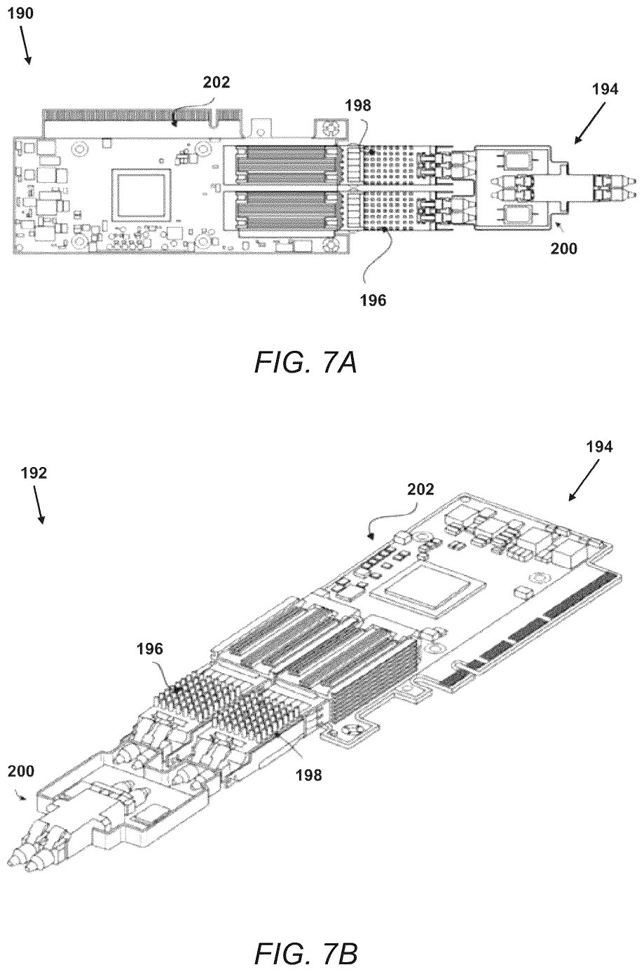

FIGS. 7A and 7B are illustrations showing a top view 190 and a perspective view 192, respectively, of an optical transceiver module 194 operatively coupled to a network adapter, according to an embodiment of the disclosure. Transceiver module 194 is generally similar in function and structure to transceivers 46.

As shown in FIGS. 7A and 7B, transceiver module 194 may include a first optical module 196, a second optical module 198, an adapter 200, and a dual-port NIC 202 of a server. Both first optical module 196 and second optical module 198 may be dual-fiber transceivers that are configured for duplex communication that allows a source (e.g., a given server) to communicate with a target (e.g., a leaf switch) in both directions. Adapter 200 may be a ganged physical component configured to link first optical module 196 and second optical module 198 for the purpose of transmitting and receiving data to and from the leaf switch.

In some embodiments, adapter 200 may be configured to operate in two configurations, such as a first configuration and a second configuration. In one aspect, the first configuration may be a default configuration of operation, where first optical module 196 may be operationally active. The second configuration may be a contingent configuration that is implemented when first optical module 196 operationally fails. When such a failure is detected, second optical module 198, which is otherwise operationally inactive or idle, may be engaged to become operationally active and handle all network traffic that was initially handled by the first optical module.

In some embodiments, transceiver module 194 may be configured to operate in a leaf-spine architecture. A leaf-spine architecture is a data center network topology that may include two switching layers-a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic.

As such, in one embodiment, to ensure reliable operation of downlinks, transceiver module 194 may be configured to operate between the server and the leaf layer. In particular, as shown in FIGS. 7A and 7B, adapter 200 may be operatively coupled to first optical module 196 and second optical module 198, while the first optical module and the second optical module may be operatively coupled to dual-port NIC 202 of a server.

In embodiments, module 194 may comprise one or more processing circuits; the processing circuits may comprise firmware that is loaded according to techniques known in the art.

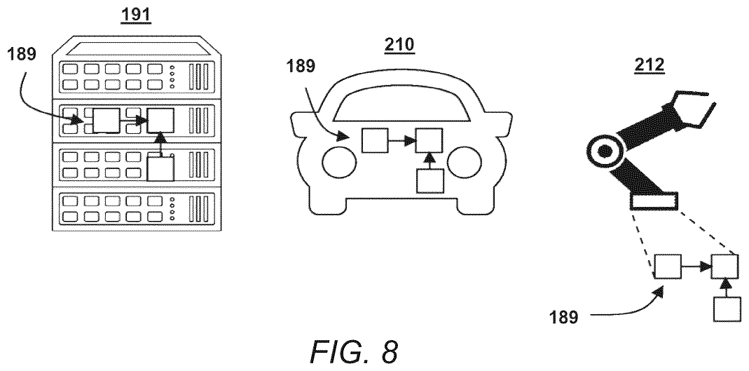

FIG. 8 depicts exemplary scenarios for use of an optical transceiver 189, according to an embodiment described herein. Transceiver 189 is generally similar in function and structure to transceivers 46. Optical transceiver 189 may be utilized in a network device 191 such as a computing system (e.g., in a server farm, or within a server computer system), a vehicle 210 (e.g., a car, truck, train, or airplane), and a robot 212 (or among robots in a factory), to name just a few examples. Optical transceiver 189 may be particularly useful for high-speed communication in environments subject to high levels of electromagnetic interference (EMI).

The disclosed systems and methods described herein may be implemented using co-packaged optical (CPO) solutions integrated with electronic switch ASICS, network processors, or AI accelerators. Optical components such as modulators, drivers, photodetectors, and laser sources may be co-packaged directly on or near the host silicon using advanced packaging technologies including 2.5D interposers or silicon bridges.

In some configurations, mid-board optical modules (MBOMs) are employed as part of the optical I/O strategy. MBOMs are positioned centrally on a printed circuit board (PCB)-between the front panel and the host die-enabling shorter electrical traces and improved signal integrity while maintaining separation between optics and high-power ASICs for thermal management.

Near-packaged optics may also be used, placing optical engines in close proximity to the host device without full co-packaging, allowing for modular deployment and gradual migration from pluggable optics.

Systems described herein may support optical connectivity through edge couplers, fiber ribbon interfaces, or on-board photonic waveguides. Silicon photonics may be used to implement optical engines within the CPO or MBOM units, with support for modulation schemes such as pulse amplitude modulation using four voltage levels (PAM4), coherent signaling, or wavelength division multiplexing (WDM).

These components may be interconnected via high-speed electrical interfaces such as SerDes lanes, and coordinated via on-board controllers that handle lane training, optical power tuning, and health monitoring.

Embodiments may scale from 400G to 1.6T and beyond, supporting deployment in high-performance computing, AI clusters, and data center switching platforms. Integration strategies may include air-cooled and liquid-cooled packages, supporting advanced thermal designs to handle the combined electrical and optical power densities.

Systems described herein may be implemented in modular switch platforms, AI training fabrics, or other environments requiring high-density, low-latency interconnect.

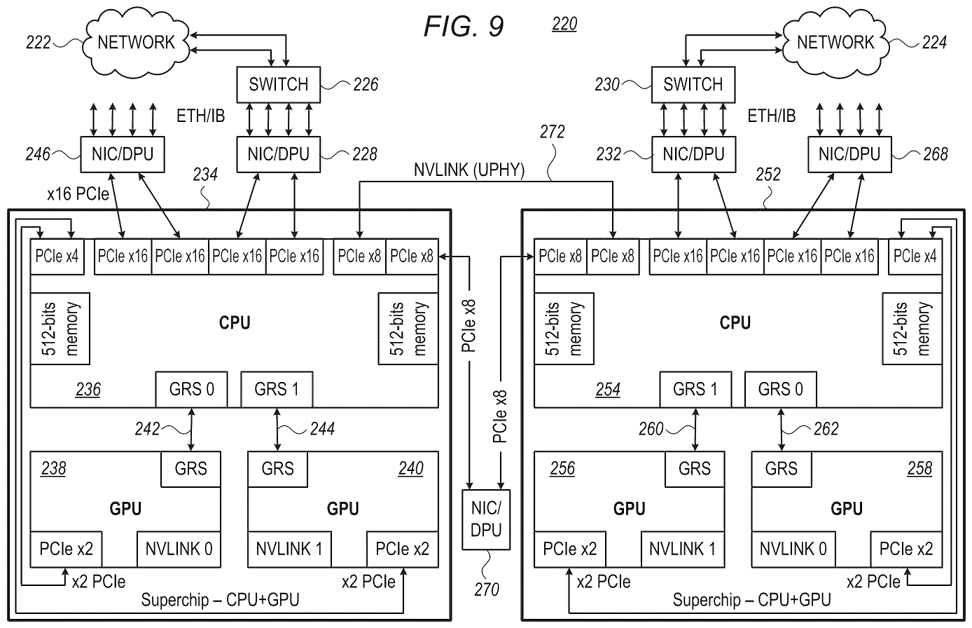

FIG. 9 is a block diagram that schematically illustrates an example of a network device, according to an embodiment described herein. In the example shown in FIG. 9, the network device comprises a computing system 220, e.g., a data center or a High-Performance Computing (HPC) cluster.

System 220 may comprise a plurality of subsystems, e.g. multiple processing devices coupled to each other, multiple network devices, and multiple networks, according to at least one embodiment. Computing system 220 can be designed with multiple integrated circuits (referred to as processing devices), where each one or more CPUs, GPUS, integrated circuit can include QPUs and/or PPUS forming a powerful and flexible architecture.

The various processing devices are interconnected via an NVLINK or other high-speed interconnect, enabling high-speed communication between the subsystems, and are also connected through a NIC or DPU to ensure efficient data transfer across computing system 220 and to one or external networks 222 and 224. In the present more example, system 220 comprises a packet switch 226 that connects a NIC/DPU 228 to data network 222, and a packet switch 230 that connects a NIC/DPU 232 to data network 224.

The coupling of processing devices through the NVLINK allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is suitable for demanding highly applications that require significant processing power, such as artificial intelligence (AI), machine learning (ML), and data-intensive computing, while ensuring robust connectivity and scalability across various networked environments. The integrated circuits of computing system 220 may include one or more CPUs and one or more GPUs.

FIG. 9 also shows an example architecture of a architecture. As illustrated in the figure, multi-GPU computing system 220 comprises a processing device 234 with a multi-GPU architecture. In particular, processing device 234 may be a system-on-chip and include multiple subsystems such as a CPU 236, a GPU 238, and a GPU 240 CPU 236 can be coupled to GPU 238 via a die-to-die (D2D) or chip-to-chip (C2C) interconnect 242, such as a Ground-Referenced Signaling interconnect (GRS interconnect). CPU 236 can be coupled to GPU 240 via a D2D or C2C interconnect 244. CPU 236 can also couple to GPU 238 and GPU 240 via PCIe interconnects.

CPU 236 can be coupled to one or more NICs or DPUs, which are coupled to one or more networks. For example, as illustrated in FIG. 9, CPU 236 is coupled to a first NIC/DPU 246, which is coupled to network 222. CPU 236 is also coupled to a second NIC/DPU 228, which is coupled to network 222 via switch 226. NIC/DPU 246 and NIC/DPU 228 can be coupled to network 222 over Ethernet (ETH), NVLINK or InfiniBand (IB) connections, for example.

Computing system 220 also includes a processing device 252 with a multi-GPU architecture. In particular, processing device 252 includes multiple subsystems including a CPU 254, a GPU 256, and a GPU 258. CPU 254 can be coupled to GPU 256 via a D2D or C2C interconnect 260. CPU 254 can be coupled to GPU 258 via a D2D or C2C interconnect 262. CPU 254 can also be coupled to GPU 256 and GPU 258 via PCIe interconnects. CPU 254 can be coupled to one or more NICs or DPUs, which are coupled to one or more networks. For example, as illustrated in FIG. 9, CPU 254 is coupled to a first NIC/DPU 268, which is coupled to data network 224. CPU 254 is also coupled to a second NIC/DPU 232, which is coupled to network 224 via a switch 230. NIC/DPU 232 and NIC/DPU 268 can be coupled to network 224 over Ethernet (ETH), NVLINK or InfiniBand (IB) connections.

In at least one embodiment, processing device 234 and processing device 252 can communicate with each other via a NIC/DPU 270, such as over PCIe interconnects. Processing device 234 and processing device 252 can also communicate with each other over a high-bandwidth communication interconnect 272, such as an NVLINK interconnect or other high-speed interconnects. The packet switches in FIG. 9 may comprise, for example, NVIDIA QUANTUM-2 switches. The NICs/DPUs in the figure may comprise, for example, NVIDIA BLUEFIELD DPUS.

In embodiments described hereinabove, transceivers 46 may be deployed as a component in computing system 220, and may be used in conjunction with devices of the system, e.g., any of NICs/DPUS 246, 228, 232, 268 and 270, and/or any of switches 226 and 230.

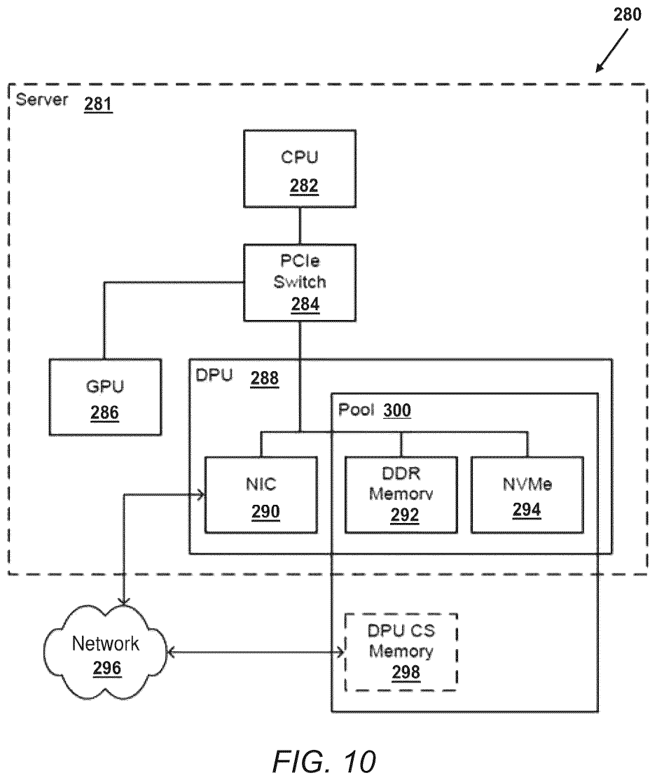

FIG. 10 illustrates an example of a computing environment 280, according to an embodiment described herein. In some embodiments, computing environment 280 may be deployed in a data center as a network device such as a server 281.

In the configuration shown in FIG. 10, computing environment 280 may be configured to implement forward pass offloading to available memory. It should be appreciated that embodiments described herein may also be used with reference to alternative environments and that specific discussion of components may be provided by way of a non-limiting example and may include equivalents. Moreover, various features have been removed for clarity and conciseness. Additionally, systems and methods may be used with a variety of different architectures. The example computing environment 280 may include server 281 which may be used to perform HPC workloads, such as AI training or machine learning model training. In an embodiment, server 281 may be an application instance or a compute node. Server 281 may include a CPU 282 associated with a switch 284 such as a peripheral component interconnect express (PCIe) switch, which may control at least some data transmission over communication paths interconnecting various components. In an embodiment, CPU 282 may include a root complex processor.

PCIe switch 284 may also be associated with a GPU 286 and a DPU 288, and may transmit data between at least some of CPU 282, GPU 286, DPU 288, and other components. In one embodiment, PCIe switch 284 may be associated with more than one GPU or more than one DPU. In another embodiment, PCIe switch 284 may be located within DPU 288. PCIe switch 284 may manage the transfer of at least some data between CPU 282, GPU 286, and DPU 288. In another embodiment, the number of GPUs associated with PCIe switch 284 may be equal to the number of DPUs associated with the PCIe switch.

In at least one embodiment, server 281 may include, without limitation, any number of the CPUs 282, the PCIe switches 284, the GPUs 286, and/or the DPUs 288, in any combination. For example, in at least one embodiment, server 281 could include eight, sixteen, thirty-two, and/or more GPUS 286. In at least one embodiment, communication paths interconnecting various components, including but not limited to CPU 282, PCIe switch 284, GPU 286, and DPU 288, in FIG. 10 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

DPU 288 may include a network interface controller (NIC) 290, a DDR memory 292, and a non-volatile memory express (NVMe) device 294. NIC 290 may be able to interface with a network 296, which may also interface with additional NVMe devices available to DPU 288, such as over fabric. In an embodiment, DPU 288 may not include NVMe device 294. In another embodiment, NVMe device 294 may be located on the server 281 and not on DPU 288. In yet another embodiment, the computing environment 280 may include more than one of NVMe device 294, such as a first NVMe device 294 in DPU 288 and a second NVMe device 294 on server 286 and associated directly with PCIe switch 284.

In an embodiment, DPU 288 may not include the DDR memory 292, and may include computational storage services (CSS) in place of, or in addition to, the DDR memory. For example, computing environment 280 may include a DPU computational storage (CS) memory 298 available to DPU 288 as part of the CSS. Network 296 may be able to interface with the DPU CS memory 298 through the NIC 290, according to any suitable interface protocol, such as remote direct memory access (RDMA) over Ethernet, InfiniBand, Fiber Channel, etc. The interfaces for network 296 may use, where appropriate, transceivers 46.

The total memory of the computing environment 280 available for data storage may be expanded through the use of DPU 288 on nodes of the system. DPU 288 may have access to a pool 300 of memory already available to server 186, such as double data rate (DDR) memory, on-board NVMe devices, NVMe devices over fabric, and CS. Pool 300 of memory may include at least one of the DDR memory 292, NVMe 294, and DPU CS memory 298. DPU 288 may also be able to access the available memory of other DPUs as part of pool 300, and other DPUs may be able to access the available memory of DPU 288, such as pool 300. This available memory can be accessed and utilized for data storage, without the addition of compute resources, such as compute nodes, which would be required using other solutions.

Available pool 300, accessible to DPU 288, may be provisioned for server 281 to expand the total memory available for data storage, such as to reduce the data storage load on CPU 282 or the GPU 286, which can instead increase the utilization of their memory for processing. For example, during training of an AI, the model states, residual states, activation functions, and checkpoints can be stored, or offloaded, on pool 300 accessible to DPU 288.

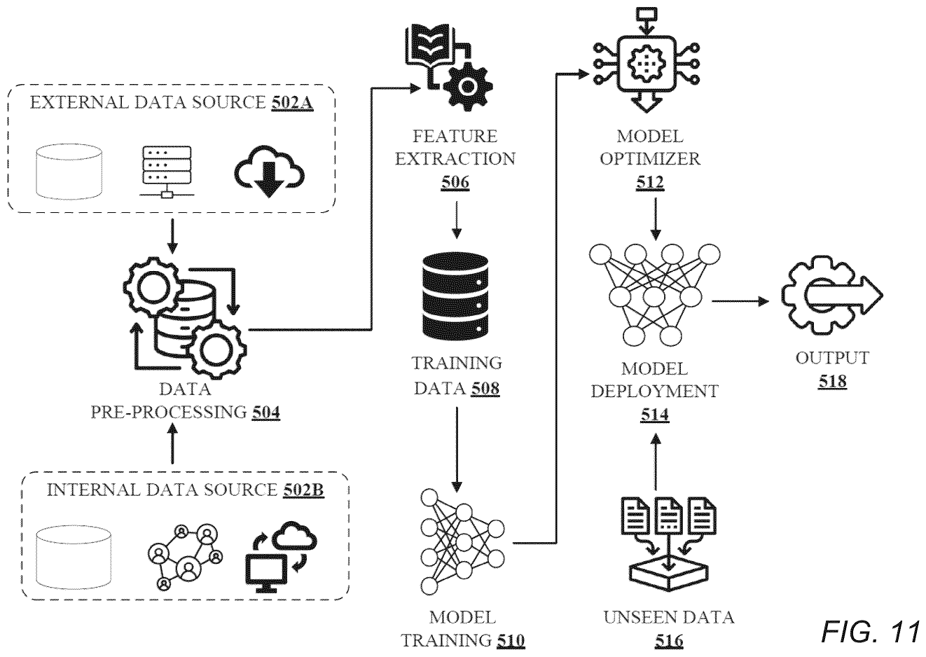

FIG. 11 illustrates an exemplary machine learning architecture, in accordance with an embodiment that is described herein. The machine learning architecture may include various external data sources 502A and internal data sources 502B to generate, test, and integrate new features for training the machine learning model. The data sources (e.g., external data sources 502A and internal data sources 502B) can be initial locations where data originates or where physical information is first digitized. The data may be transported from each data source using applicable network protocols, such as the File Transfer Protocol (FTP), Hyper-Text Transfer Protocol (HTTP), for various Application Programming Interfaces (APIs) provided by websites, networked applications, and other services.

The data sources may include logs from network traffic within routers, switches, and firewalls that capture data related to traffic patterns, access control, and data flow. In high-performance computing (HPC) systems, data may be sourced from storage arrays, computational model outputs, and simulation data repositories. For optical communication systems, data sources may include monitoring devices and systems such as transceivers, multiplexers, and demultiplexers that track signal strength, bandwidth utilization, and error rates. Additional sources include data centers containing information from servers, storage devices, and virtualization platforms; IoT and edge devices such as sensors, actuators, and smart d devices collecting and transmitting data on environmental conditions, operational metrics, and user interactions; telecommunications systems providing call detail records, network usage statistics, and performance data; network management systems (NMS) generating metrics and logs regarding network health, performance, and configuration; and cybersecurity systems providing alerts, logs, and event data from intrusion detection systems (IDS), intrusion prevention systems (IPS), and security information and event management (SIEM) systems.

The data obtained from these sources may have various structures and formats. To facilitate effective analysis, the data may be pre-processed. Data pre-processing 504 may involve several steps, including cleaning, transformation, and advanced integration and processing. Cleaning the data may involve standardizing formats, filling in missing values, smoothing out noise, resolving inconsistencies, and removing outliers. Transformation processes may include aggregating, normalizing, and encoding data into suitable structures for analysis. Advanced integration and processing steps may be implemented to prepare the data for machine learning execution. As such, advanced integration and processing steps may involve changing the value, structure, or format of the data through generalization, normalization, attribute selection, and aggregation.

Once pre-processed, the data may undergo feature extraction 506. Feature extraction and selection techniques may be implemented to generate training data 508 by reducing the dimensionality of the initial data set, making it more manageable for processing. Large data sets often contain a significant number of variables, requiring substantial computing resources. Feature extraction 506 may involve selecting and combining variables into features, thereby reducing the volume of data to be processed while maintaining an accurate and comprehensive representation of the original data set. Depending on the machine learning algorithm employed, the training data 508 may need further enrichment. For supervised learning, the training data 508 may be enhanced with meaningful labels that provide context, allowing the machine learning model to learn from it. Labels may indicate the presence of specific objects in images, transcribed words in audio recordings, or medical conditions in x-rays. Data labeling may be used in applications such as computer vision, natural language processing, and speech recognition. Recent advancements also see the integration of automated data labeling tools that leverage artificial intelligence to label data at scale, improving efficiency. In contrast, unsupervised learning utilizes unlabeled data to identify patterns, such as inferences or clusters, within the data set. Emerging techniques in unsupervised learning, like self-supervised learning and contrastive learning, are increasingly being adopted to improve the ability of models to understand and organize data without manual labeling.

The resulting training data 508 may be used to train the machine learning model 510. Training a machine learning model involves using a training framework to process the training data 508, enabling the model to make predictions or decisions without explicit programming. The trained model encapsulates the knowledge acquired by the selected machine learning algorithm, which includes rules, numerical parameters, and algorithm-specific data structures required for tasks such as classification. Selecting the appropriate machine learning algorithm may depend on various factors, such as the problem statement, desired output, data type and size, available computational resources, and the number of features and observations in the data. Machine learning algorithms, which consist of mathematical and logical programs, are designed to self-adjust and improve as they are exposed to more data. These machine learning algorithms can modify their parameters based on feedback from previous performance in predicting outcomes on a dataset. Training frameworks such as TensorFlow, Boost, Caffe, Microsoft Cognitive Toolkit/CNTK, MXNet, Chainer, Keras, Deeplearning4j, and others facilitate this training process by providing the necessary tools and libraries to build, train, and optimize machine learning models.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like.

In the context of deep neural networks, training may involve using the frameworks to handle complex, multi-layered neural networks. The process typically includes data preparation, where pre-processed training data is fed into the neural network, which may be labeled or unlabeled depending on the type of learning. During forward propagation, input data may pass through the network's layers, with each layer performing calculations and transformations based on its parameters. The network's output may then be compared to the expected output using a loss function to calculate the error. In backpropagation, this error may be propagated back through the network, and the training framework adjusts the network's weights and biases to minimize the error. Optimization algorithms, such as stochastic gradient descent, Adam, or RMSprop, may be used to update the model's parameters iteratively. Such an iterative process of forward propagation, loss calculation, backpropagation, and optimization may continue for many epochs until the model's performance reaches a satisfactory level.

In supervised learning, the training data 508 may include inputs paired with desired outputs. The training framework may process these inputs and compare the resulting outputs against expected outputs, propagating errors back through the model and adjusting the weights iteratively to improve accuracy until the model achieves the desired performance. For example, in training a neural network, this involves forward propagation of inputs through the network layers, calculation of the loss based on the difference between actual and expected outputs, and backpropagation to update the network weights. In unsupervised learning, the training data 508 may include unlabeled data, and the machine learning model may attempt to find patterns or groupings within this data using techniques such as self-organizing maps, clustering algorithms, or dimensionality reduction methods like autoencoders. These methods enable the model to identify underlying structures in the data without predefined labels. Semi-supervised learning may combine both labeled and unlabeled data, leveraging the labeled data to guide the learning process while also extracting patterns from the unlabeled data. Semi-supervised learning may be particularly useful when labeled data is scarce or expensive to obtain. For instance, a neural network can be trained with a mix of labeled and unlabeled images, using the labeled data to establish initial learning parameters and the unlabeled data to refine and expand the model's understanding. Incremental learning, including techniques such as transfer learning, may allow a trained machine learning model to adapt to new data without forgetting previously learned knowledge, which is especially useful for applications where the model needs to continuously learn from new data. For example, a neural network can leverage transfer learning to apply knowledge gained from one task to improve performance on a related task. Furthermore, techniques such as self-supervised learning, where the model generates its own labels from the data, and contrastive learning, which improves the model's ability to understand the relationships between data points, have enhanced the efficiency and effectiveness of training machine learning models. These methods enable models to learn from large amounts of unlabeled data and improve their generalization capabilities. By utilizing these training frameworks and techniques, machine learning models, particularly deep neural networks, can be trained to achieve high accuracy and robust performance across a wide range of applications.

Once trained, the machine learning model may be optimized using a model optimizer 512. The model optimizer 512 may streamline the transition from the training environment to deployment by performing various optimization tasks, such as resizing inputs, modifying batch sizes, quantizing weights, and/or the like to enhance the model's performance and efficiency. By generating an internal representation of the model, the model optimizer 512 may adjust its structure to reduce computational overhead, ensuring effective operation across different hardware platforms, such as GPUs, CPUs, and FPGAS. Such optimization may improve the model's scalability and execution speed, making it more suitable for practical use.

Once the machine learning model is trained and optimized, it can be deployed 514 into a production environment for practical use. Deployment 514 may involve integrating the trained model into an application or system where it can process live data and make real-time predictions or decisions. The deployment 514 process may include several steps such as exporting the model from the training framework, converting it into a format suitable for the target environment, and optimizing it for performance and scalability. The trained machine learning model can be deployed 514 on various platforms, including cloud services, edge devices, or on-premises infrastructure. During deployment 514, the trained machine learning model may be monitored and maintained to track its performance, manage updates, and address any issues that arise.

Unseen data 516, referred to as test data or live data, is new information that the trained machine learning model has not encountered during its training phase. The unseen data 516 data may be introduced to evaluate the trained machine learning model's ability to generalize and make accurate predictions on previously unknown inputs. Unseen data 516 may originate from various sources similar to those used during training (e.g., external data sources 502A and internal data sources 502B), such as logs, sensor readings, or user-generated content, but it has not been included in the dataset used to train the model. The introduction of unseen data 516 may be used to assess the model's real-world performance and its capacity to handle a diverse range of inputs beyond the training data 508.

When unseen data 516 is fed into the trained model, the model processes this data to generate an output 518. This output 518 may take various forms depending on the nature of the machine learning task. For instance, in a classification task, the output 518 may be a label or category prediction, such as identifying an object in an image or detecting sentiment in a text. In regression tasks, the output 518 may be a continuous value, such as predicting house prices based on market data. For models used in natural language processing or computer vision, the output 518 may include sequences of text, transcriptions, or detailed image annotation.

Once the model generates an output 518, the output 518 may be transmitted to a user device or integrated into a larger system for practical application. The output 518 may be formatted and packaged into a suitable data structure, such as JSON or XML, which can be interpreted by the receiving system. This packaged output may then be transmitted over a network using protocols such as HTTP or through application programming interfaces (APIs). The receiving user device, which may be a smartphone, tablet, or desktop computer, may process the received data to present it to the user. Such processing may involve rendering visual predictions on a screen, generating alerts or notifications, or integrating the output into a user-facing application interface.

The machine learning architecture described herein may support heterogeneous execution, which refers to the ability to run different portions of a program on different types of processors and cores, leveraging the strengths of various hardware components, such as running compute-intensive tasks on GPUs while utilizing CPUs for sequential processing. Such an approach may maximize the efficiency and speed of machine learning applications (e.g., deep neural network applications), making it ideal for complex and resource-demanding tasks.

It will be understood that the embodiment of the machine learning architecture illustrated in FIG. 11 is exemplary and that other embodiments may vary. For instance, in some embodiments, the machine learning architecture may include additional, fewer, or different components. Variations in the configuration of the components and the implementation of the processes described herein are anticipated and within the scope of this disclosure. Modifications may include, but are not limited to, the integration of alternative data sources, different optimization incorporation of advanced algorithms and methodologies. The scope of the disclosure is not limited to the specific configurations and components described herein, and various modifications and adaptations may be made by those skilled in the art without departing from the spirit and scope of the disclosure. This disclosure encompasses any such variations, adjustments, or enhancements that maintain the core functionality and purpose of the machine learning architecture.

The ML architecture described herein can be employed in a wide range of applications, including but not limited to genomics, cognitive computing, and various machine learning tasks. These tasks may involve training or inferencing software, as well as machine learning frameworks such as PyTorch, TensorFlow, Caffe, and other relevant software used in conjunction with one or more embodiments.

Although the embodiments described herein mainly address network links in a computing system, the methods and systems described herein can also be used in other applications. One alternative application is a bus communication system, e.g., a system comprising multiple system components that communicate with one another over a PCIe bus or other system bus. Such a system typically comprises multiple PCIe links, wherein a given PCIe link (i) comprises multiple lanes, and (ii) comprises multiple test points (TPs) that enable telemetry extraction along the link.

It will thus be appreciated that the embodiments described above are cited by way of example, and that the present disclosure is not limited to what has been particularly shown and described hereinabove. Rather, the scope of the disclosure includes both present combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
an interface, to receive performance measurements for a multi-lane communication link comprising transmission (TX) circuitry and reception (RX) circuitry that communicate with one another over a communication medium in multiple lanes; and
a processor, to:
calculate (i) a TX-side variation, between at least two of the lanes, in a TX-side performance measurement associated with the TX circuitry, and (ii) an RX-side variation, between the at least two of the lanes, in an RX-side performance measurement associated with the RX circuitry;
compare the TX-side variation with the RX-side variation; and
diagnose a health status of the link depending on comparison of the TX-side variation and the RX-side variation.

2. The system according to claim 1, wherein, in diagnosing the health status, the processor is to detect a fault in the link depending on the comparison of the TX-side variation and the RX-side variation.

3. The system according to claim 2, wherein, based on the comparison, the processor is to identify one or both of:
a type of the fault; and
a location of the fault along the link.

4. The system according to claim 2, wherein, in detecting the fault, the processor is to detect a condition indicative of potential future failure.

5. The system according to claim 2, wherein, in detecting the fault, the processor is to verify that the fault is persistent and not transient.

6. The system according to claim 2, wherein the processor is to select and output a recommended corrective action for correcting the fault.

7. The system according to claim 1, wherein the processor is to perform an analysis of multiple different types of performance measurements associated with the TX circuitry and the RX circuitry, and, based on the analysis, to generate a prioritized list of recommended corrective actions.

8. The system according to claim 1, wherein the processor is to correlate the health status with production-stage data of one or both of the TX circuitry and the RX circuitry of the link.

9. The system according to claim 1, wherein the processor is to issue an alert in response to the health status.

10. The system according to claim 1, wherein the RX-side variation comprises a variation in an error metric between the at least two of the lanes, and the TX-side variation comprises a variation in a signal quality metric between the at least two of the lanes.

11. The system according to claim 1, wherein the processor is to compare the TX-side variation with the RX-side variation upon finding that the RX-side variation exceeds a defined threshold.

12. The system according to claim 1, wherein the link is an electro-optical link, and wherein the communication medium is an optical fiber.

13. The system according to claim 1, wherein the link is part of a network comprising additional links, and wherein the processor is to receive telemetry from the link and from one or more of the other links, and to reconstruct a topology of the network based on the telemetry.

14. The system according to claim 13, wherein the processor is to identify a network misconfiguration based on the reconstructed topology of the network.

15. The system according to claim 1, wherein, upon detecting that the link is down, the processor is to assess whether the link is down due to performance or due to intentional deactivation by a user.

16. The system according to claim 15, wherein the processor is to assess whether the link is down due to performance or due to intentional deactivation, based on a comparison of event counts or timer values associated with the TX circuitry and the RX circuitry.

17. The system according to claim 1, wherein, in diagnosing the health status, the processor is to distinguish between a physical fault and an electrical fault in the link.

18. The system according to claim 1, wherein the processor is to evaluate a Bit Error Rate (BER) using a series of sliding-window calculations, wherein a given sliding-window calculation evaluates the BER over bits contained in a span of multiple defined window durations, the span being shifted relative to the span of a previous sliding-window calculation.

19. A method, comprising:
receiving performance measurements for a multi-lane communication link comprising transmission (TX) circuitry and reception (RX) circuitry that communicate with one another over a communication medium in multiple lanes;
calculating (i) a TX-side variation, between at least two of the lanes, in a TX-side performance measurement associated with the TX circuitry, and (ii) an RX-side variation, between the at least two of the lanes, in an RX-side performance measurement associated with the RX circuitry;
comparing the TX-side variation with the RX-side variation; and
diagnosing a health status of the link depending on comparison of the TX-side variation and the RX-side variation.

20. The method according to claim 19, wherein diagnosing the health status comprises detecting a fault in the link depending on the comparison of the TX-side variation and the RX-side variation.
